(19) United States
(12) Patent Application Publication
(10) Pub. No.: US 2012/0290292 A1
(43) Pub. Date: Nov. 15, 2012

(54) UNSTRUCTURED DATA SUPPORT WITH AUTOMATIC RULE GENERATION

(75) Inventors: Jing Liu, Shanghai (CN); Wuzhen Xiong, Shanghai (CN); Edison Tedjing, Shanghai (CN)

(73) Assignee: Business Objects Software Ltd., Dublin (IE)

(21) Appl. No.: 13/185,332

(22) Filed: Jul. 18, 2011

(30) Foreign Application Priority Data
May 12, 2011 (CN) 201110122097.X

(51) Int. Cl. G06F 17/27

(52) U.S. Cl. 704/9; 704/E11.001

(57) ABSTRACT

A system to process unstructured data is provided. An example system to process unstructured data comprises a receiver to access a source of unstructured data, an entity type module to determine an entity type, a rules generator to automatically generate a linguistic rule based on the determined entity type, and an entity extractor to obtain an entity from the source of unstructured data, using the linguistic rule. The entity comprises an alpha-numeric string.

### CLAIM OF PRIORITY

The present patent application claims the priority benefit of the filing date of Chinese Application (SIPO) No. 201110122097.X filed May 12, 2011, the entire content of which is incorporated herein by reference.

### TECHNICAL FIELD

This application relates to the field of data processing and specifically to a method and system for automatically generating linguistic rules for unstructured data.

### BACKGROUND

Unstructured data refers to computerized information that either does not have a data structure or has one that is not easily usable by a computer program. Unstructured data may originate from multiple sources, such as, e.g., emails, websites, financial reports, etc. Unstructured data may thus be contrasted with structured data such as information stored in a field-based format in databases or semi-structured data that is annotated (for example, semantically tagged) data in electronic documents. Meanwhile, research shows that a great percentage of all potentially usable business information originates in unstructured form, such as in emails, web pages, financial reports, etc.

Some existing systems are capable of extracting, from unstructured data sources, information that has been identified as associated with predetermined categories. Some systems even permit processing unstructured data containing text in a foreign language. Unstructured data may be processed using linguistic rules. One of the challenges, however, is that a specific linguistic rule may be required for detecting and extracting data instances of different data type. For instance, one set of specific linguistic rules may need to be written to process unstructured data containing descriptions of real property, while a different set of specific linguistic rules may need to be written to process unstructured data containing local business news. The linguistic rule authoring may be a complicated process that requires particular skills and knowledge that is typically outside of a business user's area of expertise.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment, within which a system for processing unstructured data may be implemented, in accordance with one example embodiment;

FIG. 2 is a block diagram of a system for processing unstructured data, in accordance with one example embodiment;

FIG. 3 is a flow chart of a method for processing unstructured data, in accordance with one example embodiment;

FIG. 4 is a diagrammatic representation of a source of unstructured data, in accordance with one example embodiment;

FIG. 5 is a diagrammatic representation of a selection view, in accordance with one example embodiment;

FIG. 6 is a diagrammatic representation of a report generated based on processed unstructured data, in accordance with one example embodiment; and

FIG. 7 is a diagrammatic representation of an example machine in the form of a computer system within which instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that embodiments of the present invention may be practiced without these specific details.

Computer-implemented method and system may be provided to automatically generate linguistic rules for processing unstructured data, based on selected entity types. The phrase entity type, in the context of the present description, refers to a type or a category of alpha-numeric information. A specific alpha-numeric string that was identified as associated with an entity type and therefore extracted from unstructured data sources may be referred to as an entity. In one example embodiment, a system for processing unstructured data with automatic rules generation combines the features of text analysis and enterprise reporting technologies and allows users to report information based on their unstructured data input. Entities are extracted by using linguistic rules that are automatically generated based on one or more entity types.

Linguistic rules are statements written using regular expressions and linguistic attributes that define patterns for the entities, events, and relations within a source of unstructured data. Linguistic rules may be written (e.g., using a computer-implemented development tool or automatically according to some embodiments described herein), compiled, and made available to the extraction engine that may be provided with an application executing at a computer system. The extraction engine may be configured to identify and extract information from a sources of unstructured data based on the linguistic rules.

An entity type may be a pre-defined entity type. Pre-defined entity types may include, for example, entity types that commonly occur in sources of unstructured data related to a variety of topics. Examples of such common entity types (also referred to as generic entity types for the purposes of the present description) are address, date, email, phone, etc. Example text related to address information that may appear in a source of unstructured data and a linguistic rule for entity type address is shown below in Table 1.

TABLE 1

```
Address: 555 Fifth Ave, New York, NY
#group Address: ([TE ADDRESS|FACILITY@PATH]<>+[/TE])
    (<((a|A)t|(n|N)ear)> ([TE
    ADDRESS|FACILITY@PATH]<>+[/TE]))?
```

Example text related to date that may appear in a source of unstructured data information and a linguistic rule for entity type date is shown below in Table 2.

TABLE 2

Date: September 11, 2009
#group Date: [TE DATE]<>+[/TE]

Example text related to email information that may appear in a source of unstructured data and a linguistic rule for entity type email is shown below in Table 3.

TABLE 3

Email: john.doe@sap.com
#group Email: [TE URI]<>+[/TE]

Example text related to phone information that may appear in a source of unstructured data and a linguistic rule for entity type phone is shown below in Table 4.

TABLE 4

Phone: 555-123-4567
#group Phone: [TE PHONE]<>+[/TE]

The rules shown above in Tables 1-4 may be either pre-defined or automatically generated in response to a request to process a source of unstructured data (e.g., a web page or an email message). For some entity types it may be beneficial to provide more than one linguistic rule in order to extract more precise and/or complete information from an unstructured data source. For example, where an unstructured data source is related to a real property listing, it may be beneficial to extract data related to various aspects of the real property, such as, e.g., the number of bedrooms. Example linguistic rules for extracting information about bedrooms described or mentioned in a real estate advertisement are shown below in Table 5.

TABLE 5

#subgroup bedroom: <(b|B)edroom(s)?>
#subgroup modifier: <POS:Adj|Adv>
#group Bedroom: [NP] <POS:Det>? %(modifier)*
<POS:Num>?%(bedroom) [/NP]

As can be seen in Table 5 above, there are two subgroup rules and one group rule for the entity type bedroom. The bedroom subgroup represents possible writing styles of the word “bedroom”—capitalized and non-capitalized. The modifier subgroup represents words adjectives or adverbs derived from the word “bedroom.” And, finally, the Bedroom group represents the possible related semantic descriptions of the word “bedroom,” such as, e.g., “spacious” or “master.” As mentioned above, these rules may be generated manually (which requires specialized knowledge of a rules language) or automatically, according to some embodiments of the present invention, using a linguistic rules generator. In one embodiment, each rule shown in Table 5 may be generated automatically, e.g., based on a predefined rule template, by replacing one or more placeholders in the template with the keyword or with a part of the keyword.

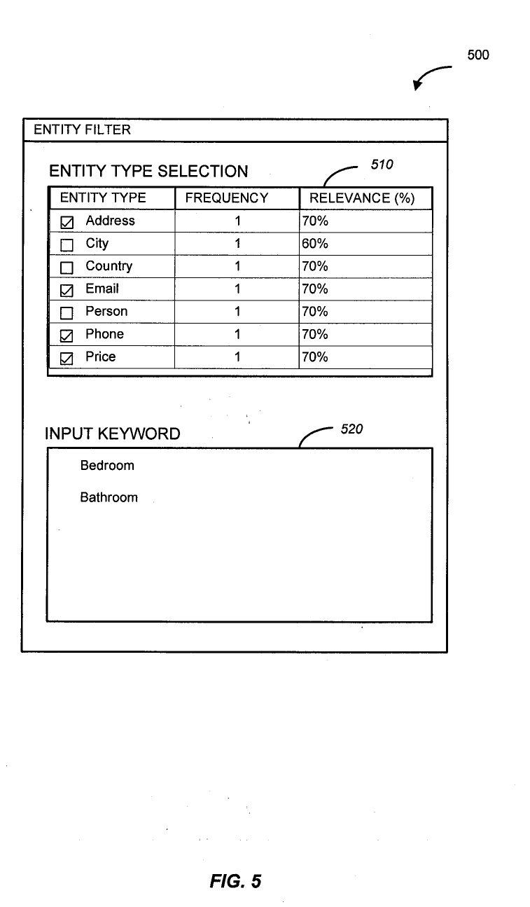

In some embodiments, a system for processing unstructured data may be configured to permit pre-defined (or generic) entity types, as well as custom entity types. Custom entity types may be generated based on one or more user-supplied keywords. An example linguistic rule generator may be configured to automatically generate linguistic rules for both pre-defined and custom entity types. For example, the system for processing unstructured data may detect that a user entered a certain keyword (e.g., “bathroom”) to indicate an interest in any references to a bathroom that may be found in a real estate listing. A user may be permitted to supply a keyword to be used in creating a custom entity type via a selection view that is described further below with reference to FIG. 5. The user-supplied keyword “bathroom” may then be treated as a custom category type and the system may automatically generate one or more linguistic rules for extracting, from a real estate listing, information related to bathrooms. The linguistic rules may be designed to extract, from a source of unstructured data, the word bathroom and its possible variants (e.g., singular and plural form), as well as adjectives and/or adverbs describing a bathroom.

In one embodiment, a system for processing unstructured data may have access to previously-stored rule templates that comprise one or more placeholders. When a user-supplied keyword and a request to treat it as a custom entity type are detected, the previously-stored one or more rule templates are accessed, and the placeholders are automatically replaced with the keyword or with a part of the keyword. A placeholder in a rule template may also be replaced by a keyword corresponding to a previously-defined (or generic) entity type, such that a linguistic rule may be generated for the previously-defined entity type. A template having its placeholder replaced by a keyword is then used as an automatically generated linguistic rule. Example linguistic rules generated for the entity type bathroom are shown above in Table 5.

In order to permit a user to request a custom entity type, a system for processing unstructured data may be configured to provide to a user a selection view for displaying one or more pre-defined entities, as well as an input field to permit a user to type in one or more keywords representing custom entity types. A selection view may be designed to present to a user, together with the pre-defined entity types, additional information associated with the entity types that may aid the user in determining whether to select a particular entity type. Such additional information may include frequency with which entities of respective entity types appear in unstructured data sources on average, as well as relevance of the entity type to the particular source of unstructured data. The users can thus select and unselect pre-defined entity types via the selection view. The system for processing unstructured data may be configured to automatically generate linguistic rules for those pre-defined entity types that have been selected and for custom entity types generated based on user-supplied keywords, but to ignore those pre-defined entity types that were not selected.

While a system for processing unstructured data may store generic entity types, the system may also be configured to permit custom entity types based on user-supplied keywords and to automatically generate linguistic rules for custom entity types. For example, while generic entity types may include address and phone number entity types, a user may be interested in extracting, e.g., from web pages related to real estate advertisements, information regarding the rental properties, such as the number and description of bedrooms and bathrooms.

The data extracted from unstructured data sources using automatically generated linguistic rules may be further processed, e.g., using statistical analysis approaches, to remove text identified as unwanted or irrelevant information in order to improve the quality of the extracted data. After the additional processing, the extracted data may be rendered into a two-dimensional table for presentation to the user. In some embodiments, the automated linguistic rule generator may highlight a series of semantic suggestions of each extracted data set.

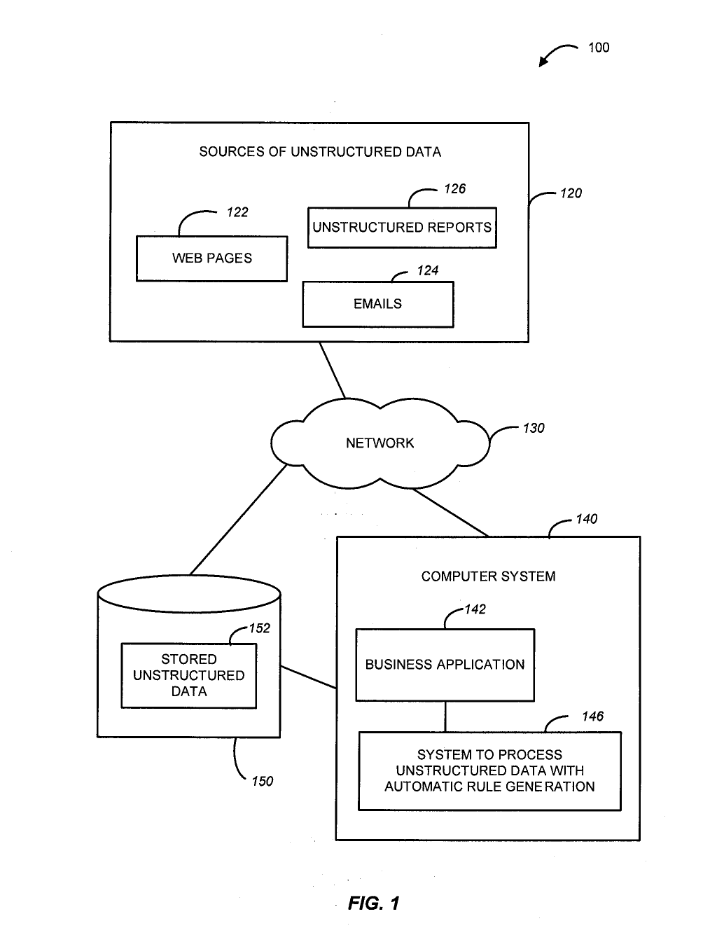

An example system to process unstructured data may be implemented in the context of a network environment 100 illustrated in FIG. 1. As shown in FIG. 1, the network environment 100 may include a server computer system 140 and sources of unstructured data 120. The computer system 140, in one example embodiment, hosts a business application 142 and a system to process unstructured data 146. The sources of unstructured data 120 may include, for example, web pages 122, emails 124, unstructured reports 126 (e.g., financial reports), etc.

The system to process unstructured data 146 may be configured to automatically generate linguistic rules associated with generic and custom entity types and extract, based on the generated linguistic rules, information (entities) from the sources of unstructured data 120 via a communications network 130. The communications network 130 may be a public network (for example, the Internet, a wireless network, etc.) or a private network (for example, a local area network (LAN), a wide area network (WAN), Intranet, etc.).

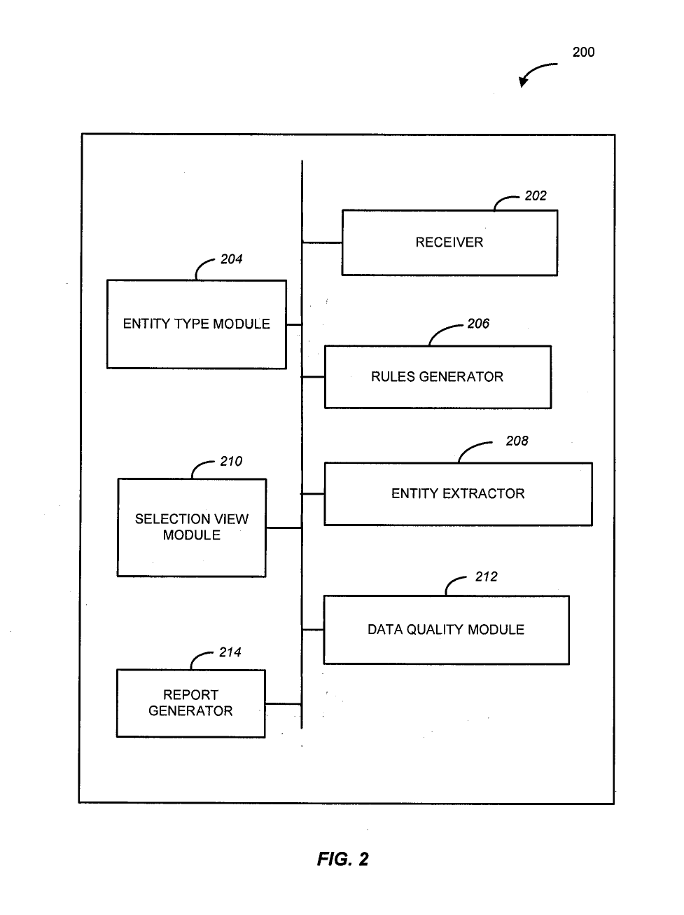

Information extracted from sources of unstructured data using automatically generated linguistic rules may be provided to the business application 142 that, in turn, may use this structured data to generate one or more reports. In some embodiments, the reports may be generated by the system to process unstructured data 146. The reports may be then provided to the business application 142. As shown in FIG. 1, the computer system is in communication with a repository 150. The repository 150 may store unstructured data 152 that may also be processed by the system to process unstructured data 146. An example system to process unstructured data is illustrated in FIG. 2.

FIG. 2 is a block diagram of a system 200 for processing unstructured data, in accordance with one example embodiment. Various modules of the system 200 may be implemented in hardware. In some embodiments, the modules of the system 200 may be implemented as software or a combination of software and hardware. As shown in FIG. 2, the system 200 includes a receiver 202, an entity type module 204, a rules generator 206, an entity extractor 208, and a selection view generator 210.

The receiver 202 may be configured to access a source of unstructured data, e.g., a web page containing a real estate listing. The entity type module 202 may be configured to determine an entity type that is to be used for parsing the source of unstructured data. The entity type module 202 may execute in conjunction with the selection view generator 210, which may be configured to provide a selection view displaying generic entity types, as well as an input field to permit a user to specify one or more keywords that can then be used as custom entity types. An example selection view is described further below, with reference to FIG. 5.

The rules generator 206 may be configured to automatically generate a linguistic rules based on one or more respective entity type that may be determined, e.g., utilizing a selection view generated by the selection view generator 210. The entity extractor 208 may be configured to obtain an entity from the source of unstructured data, using the linguistic rules generated by the rules generator 206. The system 200 may also include a data quality module 212 to remove text identified as unwanted or irrelevant information in order to improve the quality of the extracted data and a report generator 214 that may be configured to generate a report (e.g., two-dimensional table containing extracted entities) for presentation to the user.

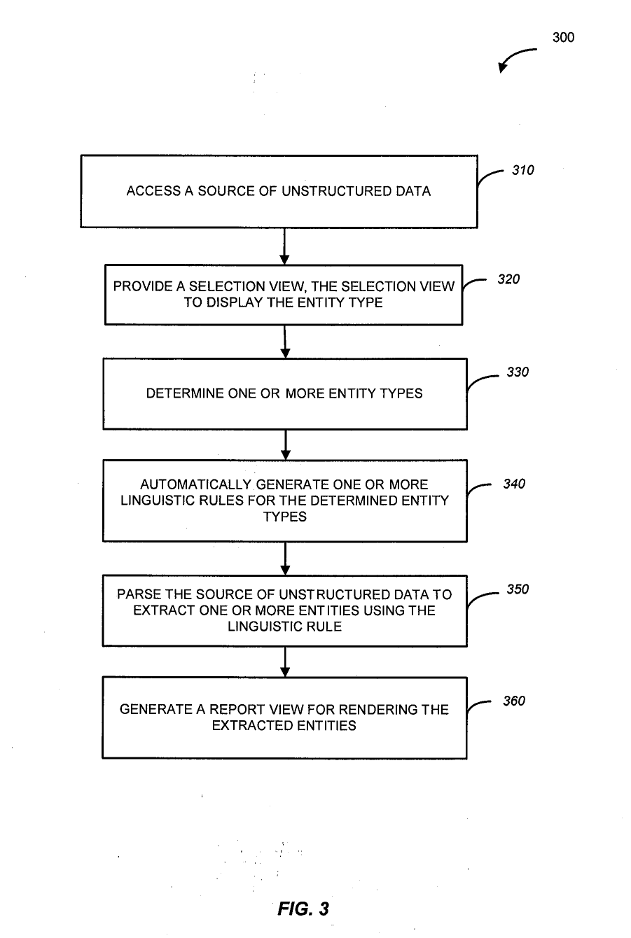

As mentioned above, components of the system 200 to process unstructured data may be implemented as hardware, software, or a combination thereof. For example, one or more modules of the system 200 may be implemented in hardware. In one embodiment, one or more modules of the system 200 may be implemented by one or more processors. It will be noted, that embodiments may be provided where some modules of the system 200 shown as separate components are implemented as a single module. Conversely, embodiments may be provided where a component that is shown in FIG. 2 as a single module may be implemented as two or more components. Example operations performed by the system 200 in order to process unstructured data may be described with reference to FIG. 3.

FIG. 3 is a flow chart of a method 300 to process unstructured data, in accordance with an example embodiment. The method 300 may be performed by processing logic that may comprise hardware (for example, dedicated logic, programmable logic, microcode, etc.), software (such as run on a general purpose computer system or a dedicated machine), or a combination of both. In one example embodiment, the processing logic resides at the computer system 140 of FIG. 1 and, specifically, at the system 200 shown in FIG. 2 that may be configured to process unstructured data utilizing automatically generated linguistic rules.

As shown in FIG. 3, the method 300 commences at operation 310, where the receiver 602 accesses a source of unstructured data, such as, e.g., a web page, an email message, etc. At operation 320, a selection view generated by the selection view module 210 of FIG. 2 is provided to a client computer system operated by a user. At operation 330, the entity type module 204 of FIG. 2 determines an entity type that is to be used by the entity extractor 208 of FIG. 2. At operation 340, the rules generator 206 of FIG. 2 generates one or more linguistic rules for the determined entity types. As mentioned above, in one example embodiment, the rules generator 206 may be configured to generate a plurality of linguistic riles for a single entity type, which would make it possible to extract additional information related to the entity type (e.g., “a beautiful remodeled kitchen” for the “kitchen entity) using descriptive words in the linguistic rules. For example, the descriptive words may include words indicating quantity (one, two, 1, 2, etc., as in “two bedrooms”), location (e.g., “5 minutes from a metro station”), adverbs or adjectives (as in “newly decorated apartment” or “a beautiful kitchen”). At operation 350, the entity extractor 208 of FIG. 2 parses the source of unstructured data and extracts one or more entities, using the linguistic rules generated by the rules generator 206 of FIG. 2. At operation 360, the report generator 214 of FIG. 2 generates a report view for rendering the extracted entities.

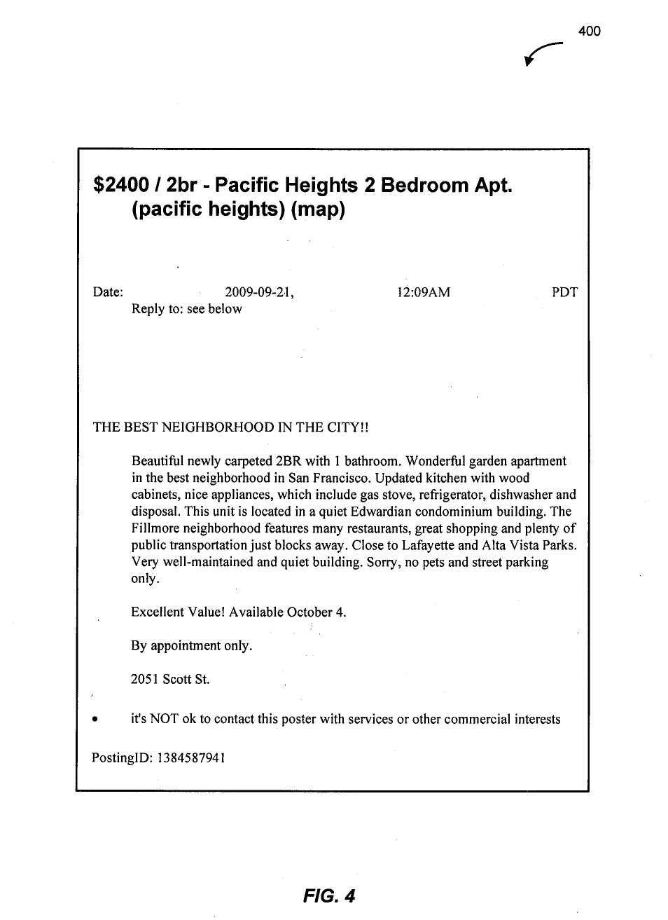

Different operations illustrated in FIG. 3 may be performed by a distributed system to process unstructured data, such that various modules or data (for example, templates or patterns) may reside at different computer systems. The operations performed by a system for processing unstructured data may be performed by one or more processors provided with one or more computer systems. An example illustrating utilizing a system for processing unstructured data with automatic rules generation is described below with reference to FIGS. 4 and 5.

FIG. 4 is a view 400 of an unstructured data source—an advertisement for a rental unit. With respect to the advertisement shown in FIG. 4, customers would probably be interested in information such as rent price, number of bedrooms and bathrooms, contact information, apartment address, etc. The method and system for processing unstructured data with automatic rules generation may be utilized beneficially to eliminate the burden on the user to manually create linguistic rules for extracting such entities.

FIG. 5 is a selection view 500 generated by the selection view module 210 of FIG. 2. As shown in FIG. 5, area 510 displays pre-defined entity types that can be selected using respective checkboxes. Area 520 displays keywords “bedroom” and “bathroom” entered by a user. The linguistic rules generated by the rules generator 210 of FIG. 2 based on user-selected entity types and user-supplied keywords are shown in Table 6 below.

TABLE 6

```
/* Address rule */
#group Address: ([TE ADDRESS|FACILITY@PATH]<>+[/TE])
    (<((a|A)t|(n|N)ear)> ([TE
    ADDRESS|FACILITY@PATH]<>+[/TE]))?
/* Email rule */
#group Email: [TE URI]<>+[/TE]
/* Phone rule */
#group Phone: [TE PHONE]<>+[/TE]
/* Price rule */
#group Price: [TE CURRENCY]<>+[/TE] (<POS:Punct> [TE
    CURRENCY]<>+[/TE])?
/* Bedroom rule */
#subgroup bedroom: <(b|B)edroom(s)?>
#subgroup modifier: <POS:Adj|Adv>
#group Bedroom: [NP] <POS:Det>? %(modifier)* <POS:Num>?
    %(bedroom) [/NP]
/* Bathroom rule */
#subgroup bathroom: <(b|B)athroom(s)?>
#subgroup modifier: <POS:Adj|Adv>
#group Bathroom: [NP] <POS:Det>? %(modifier)* <POS:Num>?
    %(bathroom) [/NP]
```

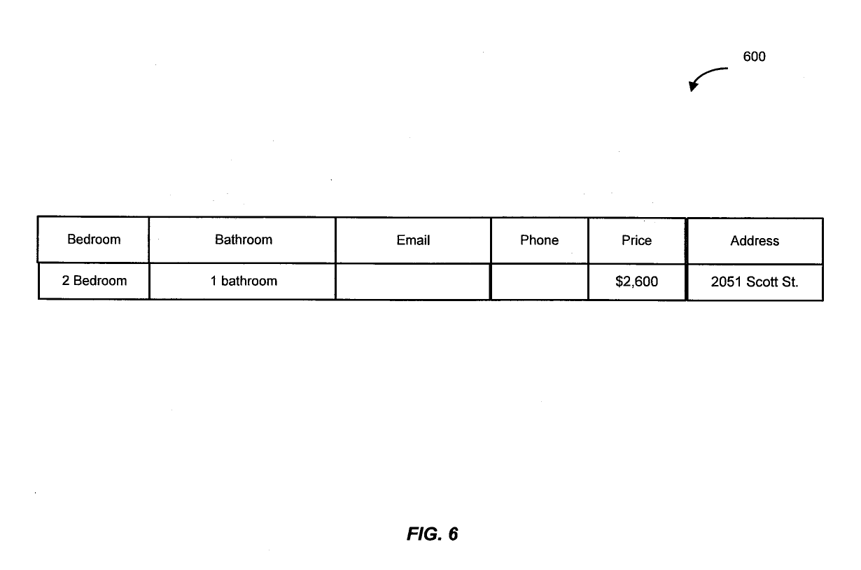

FIG. 6 is a report view 600 generated by the report generator 214 of FIG. 2. The report view 600 lists the pre-defined entities selected by the user as shown in FIG. 5 (address, email, phone, and price) and also shown custom entity types created based on user-supplied keywords (bedroom and bathroom).

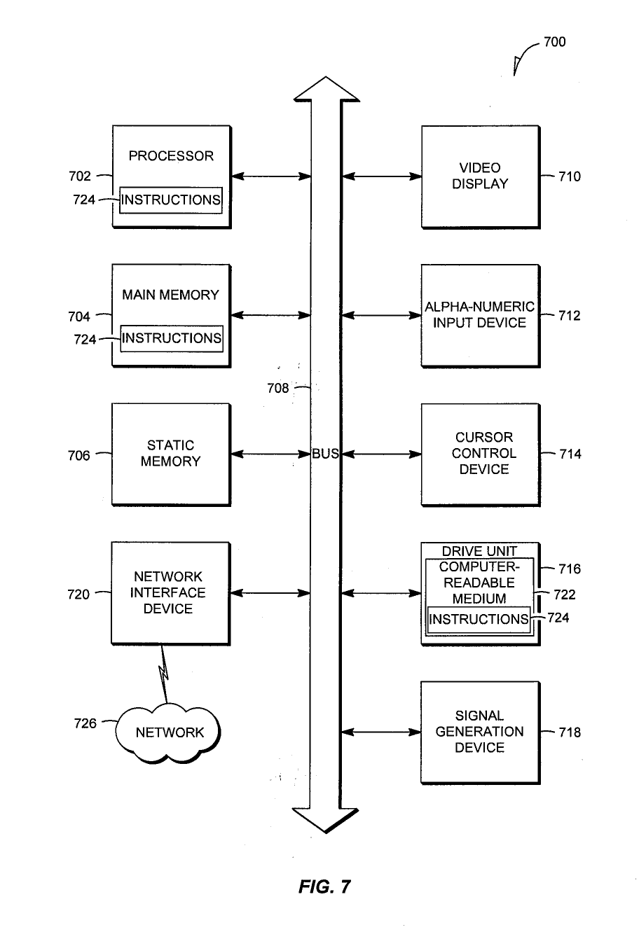

FIG. 7 shows a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (for example, networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (for example, a central processing unit (CPU), a graphics processing unit (GPU) or both), a main memory 704 and a static memory 706, which communicate with each other via a bus 708. The computer system 700 may further include a video display unit 710 (for example, a liquid crystal display (LCD) or a cathode ray tube (CRT)). The computer system 700 also includes an alpha-numeric input device 712 (for example, a keyboard), a user interface (UI) navigation device 714 (for example, a cursor control device), a disk drive unit 716, a signal generation device 718 (for example, a speaker) and a network interface device 720.

The disk drive unit 716 includes a machine-readable medium 722 on which is stored one or more sets of instructions and data structures (for example, software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (for example, Hyper Text Transfer Protocol (HTTP)).

While the machine-readable medium 722 is shown in an example embodiment to be a single medium, the term “machine-readable medium” should be taken to include a single medium or multiple media (for example, a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Embodiments of the present invention may also be directed to a system comprising means for accessing a source of unstructured data, means for automatically generating a linguistic rule based on the determined entity type; and means for obtaining an entity from the source of unstructured data, using the linguistic rule, the entity comprising an alpha-numeric string. Further embodiments of the present invention may also be directed to carrier wave signals for carrying instruction data to cause a machine to access a source of unstructured data; determine an entity type; automatically generate a linguistic rule based on the determined entity type; and obtain an entity from the source of unstructured data, using the linguistic rule, the entity comprising an alpha-numeric string.

Thus, a system to process unstructured data utilizing automatic linguistic rules generation process has been described. Method and system to automatically generate linguistic rules for processing unstructured data may be utilized advantageously to transform unstructured data into a form that is more readable and easier to process. The method and system may be used to take advantage of vast amount of unstructured data available in the World Wide Web and aid in reducing the complexity of custom linguistic rule authoring by introducing an automated linguistic rule generation that can be used to extract domain-specific information from unstructured data. In some embodiments, the method and system may be used to reduce or eliminate the need to maintain specific manually written linguistic rules. Furthermore, permitting custom entity types by obtaining user-supplied keywords may and automatically generating linguistic rules for custom entity types may improve the quality of reported data.

Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. For example, while an embodiment has been described with reference to a business application, a system to process unstructured data may be implemented and utilized advantageously in the context of various other computer applications.

1. A computer-implemented system comprising:
a receiver to access a source of unstructured data;
an entity type module to determine an entity type;
a rules generator to automatically generate a linguistic rule based on the determined entity type; and
an entity extractor to obtain an entity from the source of unstructured data, using the linguistic rule, the entity comprising an alpha-numeric string.

2. The system of claim 1, comprising a selection view module to provide a selection view, the selection view to display the entity type.

3. The system of claim 2, wherein:
the selection view comprises an input field for receiving a user-supplied keyword; and
the entity type is a custom entity type based on the user-supplied keyword.

4. The system of claim 2, wherein the selection view is to present a selection control for selecting the entity type.

5. The system of claim 4, wherein the entity type is a previously stored generic entity type.

6. The system of claim 4, wherein the selection view is to present information related to relevance of the entity type to data in the source of unstructured data.

7. The system of claim 4, wherein the selection view is to present information related to frequency with which the entity type occurs in sources of unstructured data.

8. The system of claim 1, comprising a report module to provide a report view for rendering, on a display device, the entity.

9. The system of claim 1, wherein the source of unstructured data is a web page.

10. The system of claim 1, wherein the source of unstructured data is an email.

11. A computer-implemented method comprising:
using one or more processors to perform operations of:
accessing a source of unstructured data;
determining an entity type;
automatically generating a linguistic rule based on the determined entity type; and
providing the linguistic rule to an entity extractor for obtaining an entity from the source of unstructured data using the linguistic rule, the entity comprising an alpha-numeric string.

12. The method of claim 11, comprising providing a selection view, the selection view being to display the entity type.

13. The method of claim 12, comprising receiving a user-supplied keyword via an input field in the selection view, wherein the determining of the entity type comprises generating a custom entity type based on the user-supplied keyword.

14. The method of claim 12, comprising presenting, using the selection view, a selection control for selecting the entity type.

15. The method of claim 14, wherein the determining of the entity type comprises accessing a previously stored generic entity type.

16. The method of claim 14, comprising presenting, using the selection view, information related to relevance of the entity type to data in the source of unstructured data.

17. The method of claim 14, comprising presenting, using the selection view, information related to frequency with which the entity type occurs in sources of unstructured data.

18. The method of claim 11, comprising providing a report view for rendering, on a display device, the entity.

19. The method of claim 11, wherein the source of unstructured data is a web page.

20. A machine-readable non-transitory storage medium having instruction data to cause a machine to:
access a source of unstructured data;
determine an entity type; and
automatically generate a linguistic rule based on the determined entity type, the linguistic rule being suitable to obtain an entity from the source of unstructured data, the entity comprising an alpha-numeric string.
